(19) United States
(12) Patent Application Publication
(10) Pub. No.: US 2026/0252952 A1
(43) Pub. Date: Aug. 27, 2026

(54) ITERATIVE ML POWERED HORIZON INTERPRETATION WORKFLOW

(71) Applicant: Schlumberger Technology Corporation, Sugar Land, TX (US)

(72) Inventors: Leigh TRUELOVE, Crawley (GB); Tao ZHAO, Houston, TX (US); Eso HOEKSTRA, Stavanger (NO)

(21) Appl. No.: 19/162,965

(22) PCT Filed: Jun. 24, 2024
(86) PCT No.: PCT/US2024/035256

§ 371 Date: Sep. 8, 2025

Related U.S. Application Data
(60) Provisional application No. 63/510,034, filed on Jun. 23, 2023.

(51) Int. Cl. G06N 20/00

(52) U.S. Cl. CPC G06N 20/00

(57) ABSTRACT

Methods and systems for analyzing seismic data to generate multidimensional reports are disclosed. The methods include receiving, by a data engine, seismic data captured at a resource site. The data engine may constrain a machine learning (ML) engine configured for analyzing the captured seismic data. According to one embodiment, the ML engine may be constrained using boundary condition data associated with one or more subsurface geo-properties comprised in, or associated with the seismic data. For example, the boundary condition data may indicate one or more limit data, threshold data, or some other statistical parameter used to impose bounds on the analysis executed by the ML engine. The seismic data may then be analyzed based on the constrained ML engine to generate a multidimensional report. According to one embodiment, the multidimensional report comprises 2-dimensional image data and/or 3-dimensional image data associated with a subsurface of the resource site.

### CROSS-REFERENCE TO RELATED APPLICATIONS

This application claims priority to U.S. Provisional Patent Application No. 63/510,034, filed on Jun. 23, 2023, and titled “Iterative ML Powered Horizon Interpretation Workflow,” which is incorporated herein by reference in its entirety for all purposes.

### INTRODUCTION

This disclosure is directed to an iterative approach to seismic horizon interpretation using machine learning. In particular, the disclosed technology addresses timing issues, data type and size issues, and quality control problems associated with horizon interpretation operations derived from subsurface data.

### BACKGROUND

Horizon interpretation or analysis operations include analysis or evaluation operations that provide insight into subsurface structures of, for example, a resource site. These interpretation or analysis operations are often beset with challenges/complexities that include, but are not limited to: laborious and/manual operations associated with horizon interpretation operations that are infeasible to perform by a person; significant analysis times associated with multi-horizon interpretation workflows; lack of auditability or quality control operations associated with horizon interpretation operations; lack of automatic iterations of said analysis and quality control operations resulting in biased and potentially noisy reports, etc.

There is therefore a need to address the aforementioned challenges associated with horizon interpretation processes.

### SUMMARY

This disclosure is directed to methods, systems, and computer programs for analyzing seismic data including horizon interpretation associated with a resource site. According to an embodiment, a method for analyzing seismic data comprises: receiving first seismic data captured at a resource site by one or more sensors, the first seismic data comprising subsurface information and noise data; and constraining a machine learning (ML) engine for analyzing the seismic data using a first dataset, wherein constraining the ML engine comprises customizing or labeling the ML engine with one or more boundary condition data associated with one or more subsurface geo-properties comprised in the first seismic data.

The method further comprises: analyzing the first seismic data in a first iteration based on the constrained ML engine to generate a multidimensional report; and determining whether to execute a second analysis operation on the generated multidimensional report in a second iteration based on at least one of: an update of the first dataset used for labeling the ML engine; or a second dataset distinct from the first dataset and which indicates optimized boundary condition data associated with the resource site.

In response to determining that a second analysis operation is not required, the method comprises executing, using the multidimensional report one or more of: determining an optimal site associated with the subsurface of the resource site to install a wind turbine; determining an optimal drill rate for controlling a drill bit boring one or more holes into the subsurface associated with the resource site; determining an optimal well location to guide a drill bit boring one or more holes into the subsurface associated with the resource site; determining an optimal subsurface location to store a captured gas; or executing one or more hydrocarbon exploration operations in the subsurface of the resource site.

In other embodiments, a system and a computer program can include or execute the method described above. These and other implementations may each optionally include one or more of the following features.

The boundary condition data, according to one embodiment, indicates one or more of: similar or dissimilar data points associated with the ML engine; parallel or nonparallel linear data points associated with the ML engine; or qualitative or quantitative data providing an initial data structure or data construct used by the ML engine to analyze the first seismic data.

Furthermore, analyzing the first seismic data in the first iteration based on the constrained ML engine comprises one or more of: resolving the captured seismic data using the first dataset into a defined data structure comprised in the multidimensional report; color coding one or more sections of the defined data structure comprised in the multidimensional report; linearly or nonlinearly sectioning a plurality of regions of the seismic data for inclusion in the defined data structure; or geometrically constructing one or more subsurface property information comprised in, or associated with the captured seismic data to generate the multidimensional report.

In some cases, the multidimensional report indicates one or more of: resolution information indicating one or more of rock property data comprised in the subsurface information; fluid flow condition data comprised in the subsurface information; air gap data comprised in the subsurface information; subsurface continuity or discontinuity data comprised in the subsurface information; subsurface layering data comprised in the subsurface information; hydrocarbon data associated with the subsurface information; or mineral deposit data associated with the subsurface information.

Moreover, the disclosed method can further comprise executing a quality control operation comprising at least cleaning the multidimensional report to eliminate at least one of: an error comprised in the multidimensional report, or the noise comprised in the first seismic data.

In some embodiments, the quality control operation is executed to determine whether the multidimensional report probabilistically satisfies value conditions associated with at least one of: the first dataset; historical data associated with the resource site from which the seismic data was captured; or domain information associated with the resource site.

In addition, the multidimensional report can comprise image data. It is appreciated that the multidimensional report comprises one of 2-dimensional data or 3-dimensional data, according to some embodiments.

In response to determining that a second iteration is required, the method further comprises analyzing the multidimensional report in a second iteration based on one of: the update of the first dataset used for labeling the boundary condition data; or the second dataset distinct from the first dataset and which indicates optimized boundary condition data associated with the resource site.

In other embodiments, a system and a computer program can include or execute the method described above. These and other implementations may each optionally include one or more of the following features.

The boundary condition data, according to some embodiments, indicates one or more of: similar or dissimilar data points associated with the ML engine; parallel or nonparallel linear data points associated with the ML engine; or qualitative or quantitative data providing an initial data structure or data construct used by the ML engine to analyze the first seismic data.

In some implementations, analyzing the first seismic data in the first iteration based on the constrained ML engine comprises one or more of: resolving the captured seismic data using the first dataset into a defined data structure comprised in the multidimensional report; color coding one or more sections of the defined data structure comprised in the multidimensional report; linearly or nonlinearly sectioning a plurality of regions of the seismic data for inclusion in the defined data structure; or geometrically constructing one or more subsurface property information comprised in, or associated with the captured seismic data to generate the multidimensional report.

Furthermore, the multidimensional report can indicate one or more of: resolution information indicating one or more of rock property data comprised in the subsurface information; fluid flow condition data comprised in the subsurface information; air gap data comprised in the subsurface information; subsurface continuity or discontinuity data comprised in the subsurface information, subsurface layering data comprised in the subsurface information; hydrocarbon data associated with the subsurface information; or mineral deposit data associated with the subsurface information.

In some cases, above method comprises executing a quality control operation including at least cleaning the multidimensional report to eliminate at least one of: an error comprised in the multidimensional report; or the noise comprised in the first seismic data.

Moreover, it is appreciated that the quality control operation is executed to determine whether the multidimensional report probabilistically satisfies value conditions associated with at least one of: the first dataset; historical data associated with the resource site from which the seismic data was captured; or domain information associated with the resource site.

According to some embodiments, the multidimensional report comprises image data.

In some instances, the multidimensional report comprises one of 2-dimensional data or 3-dimensional data.

In particular, the multidimensional report can comprise one of 2-dimensional image data or 3-dimensional image data associated with a subsurface of the resource site.

In response to determining that a second iteration is required, the data engine may be used to further analyze the multidimensional report in a second iteration based on one of: the update of the first dataset used for labeling the boundary condition data; or the second dataset distinct from the first dataset and which indicates optimized boundary condition data associated with the resource site.

### BRIEF DESCRIPTION OF THE DRAWINGS

The disclosure is illustrated by way of example, and not by way of limitation in the figures of the accompanying drawings in which like reference numerals are used to refer to similar elements. It is emphasized that various features may not be drawn to scale and the dimensions of various features may be arbitrarily increased or reduced for clarity of discussion.

FIG. 1 shows an exemplary high-level workflow associated analyzing seismic data to generate a multidimensional report.

FIG. 2 shows a cross-sectional view of a resource site for which the process of FIG. 1 may be executed.

FIG. 3 shows a network system illustrating a communicative coupling of devices or systems associated with the resource site of FIG. 2.

FIGS. 4A and 4B show an exemplary transition from labeling an ML engine to generating a multidimensional report.

FIG. 5 shows exemplary visualizations associated with executing a quality control operation on the transition from labeling an ML engine to generating a multidimensional report.

FIG. 6 shows a detailed workflow for analyzing seismic data to generate a multidimensional report.

### DETAILED DESCRIPTION

Reference will now be made in detail to embodiments, examples of which are illustrated in the accompanying drawings and figures. In the following detailed description, numerous specific details are set forth in order to provide a thorough understanding of the disclosed subject-matter. However, it will be apparent to one of ordinary skill in the art that this disclosure may be practiced without these specific details. In other instances, well-known methods, procedures, components, circuits and networks have not been described in detail so as not to unnecessarily obscure aspects of the embodiments.

The disclosed systems and methods may be accomplished using interconnected devices and systems that obtain a plurality of data associated with various parameters of interest at a resource site. The workflows/flowcharts described in this disclosure, according to some embodiments, implicate a new processing approach (e.g., hardware, special purpose processors, and specially programmed general-purpose processors) because such analyses are too complex and cannot be done by a person in the time available or at all. Thus, the described systems and methods are directed to tangible implementations or solutions to specific technological problems in developing natural resources such as oil, gas, water well industries, and other mineral exploration operations.

Attention is now directed to methods, techniques, infrastructure, and workflows for operations that may be carried out at a resource site. Some operations in the processing procedures, methods, techniques, and workflows disclosed herein may be combined while the order of some operations may be changed. Some embodiments include an iterative refinement of one or more data associated with the resource site via feedback loops executed by one or more computing device processors and/or through other control devices/mechanisms that make determinations regarding whether a given action, template, or resource data, etc., is sufficiently accurate.

### High-Level Workflow

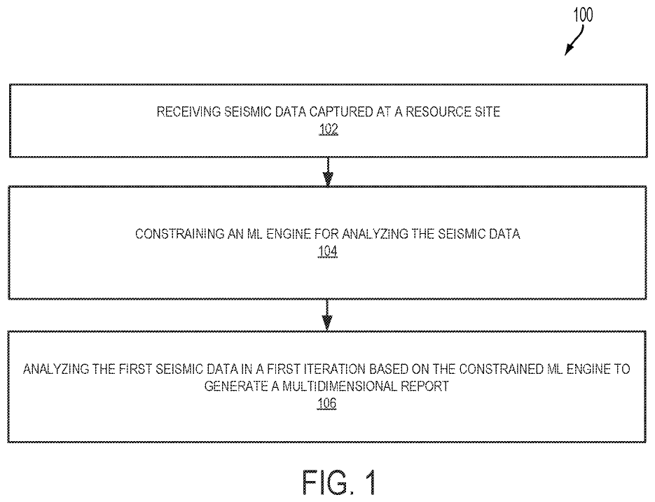

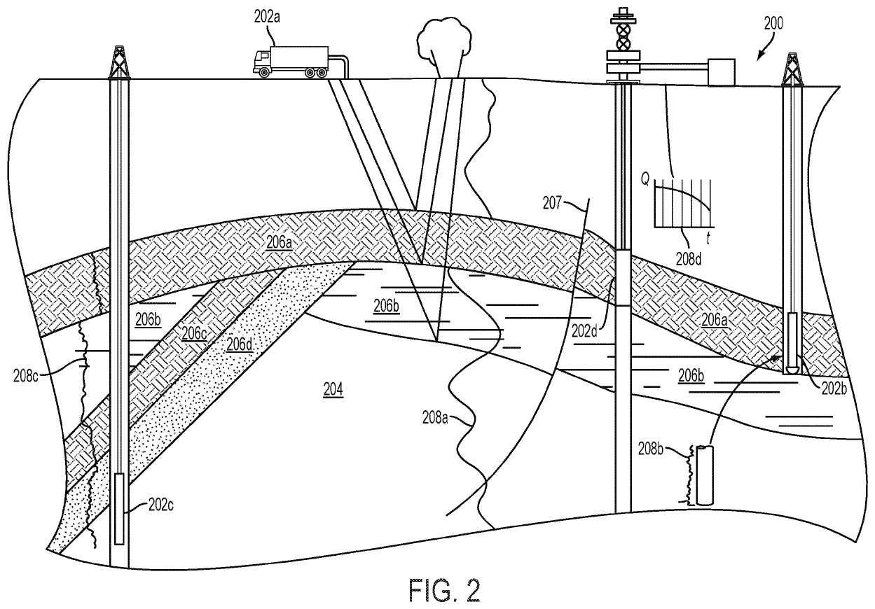

As can be seen in high-level workflow of FIG. 1, a method 100 for analyzing seismic data to generate multidimensional reports is disclosed. At block 102 a data engine or a data managing module may receive seismic data captured at a resource site. The seismic data may be captured by one or more sensors such as those discussed in conjunction with the resource site of FIG. 2 below.

At block 104, the data engine may constrain a machine learning (ML) engine configured for analyzing the seismic data. For example, the data engine may be programmed to automatically constrain the ML engine in some implementations. In other implementations, one or more inputs from, for example, a subject-matter expert, may be received by the data engine such that said inputs are used to constrain the ML engine. According to one embodiment, the ML engine may be constrained using boundary condition data associated with one or more subsurface geo-properties comprised in the seismic data. For example, the boundary condition data may indicate one or more limit data, threshold data, or other statistical parameter used to impose bounds on the analysis executed by the ML engine.

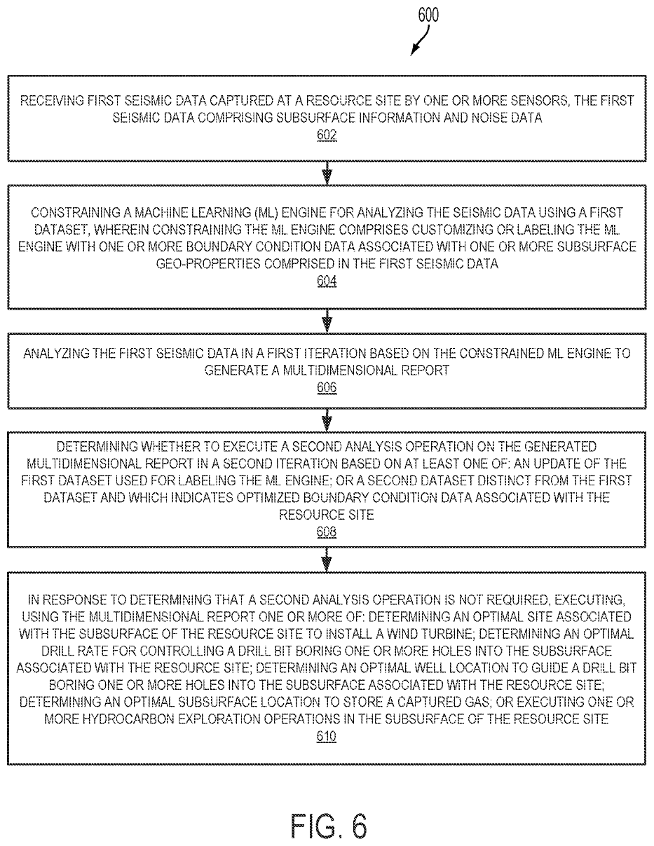

At block 106, the seismic data is analyzed by the data engine based on the constrained ML engine to generate a multidimensional report. According to one embodiment, the multidimensional report comprises 2-dimensional image data and/or 3-dimensional image data associated with a subsurface of the resource site. These aspects are further discussed in conjunction with the detailed flowchart of FIG. 6.

### Resource Site

FIG. 2 shows a cross-sectional view of a resource site 200 for which the process of FIG. 1 may be executed. While the illustrated resource site 200 represents a subterranean formation, the resource site, according to some embodiments, may be below water bodies such as oceans, seas, lakes, ponds, wetlands, rivers, or other marine environments.

According to one embodiment, various measurement tools capable of sensing one or more resource site data such as seismic two-way travel time, density, resistivity, production rate, etc., of a subterranean formation and/or geological formations may be provided at the resource site. As an example, wireline tools may be used to obtain measurement information related to geological attributes (e.g., geological attributes of a wellbore and/or reservoir) including geophysical and/or chemical information. For example, the chemical information may include chemical information associated with the subsurface and/or chemical information associated with the surface/above ground areas of the resource site 200.

In some embodiments, various sensors may be located at various locations around the resource site 200 to monitor and collect data for executing the process of FIGS. 1 and 6. In other embodiments, the techniques disclosed herein may be applied to surface seismic monitoring applications, surface gravity applications, surface electromagnetic applications, surface ground heave applications, and surface measurement of induced seismicity applications. According to some implementations, the disclosed techniques may be applied to remote sensing applications, subsea applications associated with permanent sensors, temporary sensor applications, applications associated with remotely operated vehicles, and applications associated with aerial-based measurements.

Part, or all, of the resource site 200 may be on land, on water, or below water. In addition, while a resource site 200 is depicted, the technology described herein may be used with any combination of one or more resource sites (e.g., multiple oil fields or multiple wellsites, one or more saline aquifers, one or more depleted oil/gas fields, etc.), one or more processing facilities, etc. As can be seen in FIG. 2, the resource site 200 may have data acquisition tools 202a, 202b, 202c, and 202d positioned at various locations within the resource site 200. The subterranean structure 204 may have a plurality of geological formations 206a-206d. As shown, this structure may have several formations or layers, including a shale layer 206a, a carbonate layer 206b, a shale layer 206c, and a sand layer 206d. A fault 207 may extend through the shale layer 206a and the carbonate layer 206b. The data acquisition tools, for example, may be adapted to take measurements and detect geophysical and/or chemical characteristics of the various formations shown.

While a specific subterranean formation with specific geological structures is depicted, it is appreciated that the resource site 200 may contain a variety of geological structures and/or formations, sometimes having extreme complexity. In some locations of a given geological structure, for example below a water line (e.g., aquifer) relative to the given geological structure, fluid may occupy pore spaces of the formations. Each of the measurement devices may be used to measure properties of the formations and/or other geological features. While each data acquisition tool is shown as being in specific locations in FIG. 2, it is appreciated that one or more types of measurement may be taken at one or more locations across one or more sources of the resource site 200 or other locations for comparison and/or analysis.

The data collected from various sources at the resource site 200 may be processed and/or evaluated and/or used as training data, and or used to generate high resolution result sets for characterizing a resource at the resource site, and/or used for generating resource models, etc. In one embodiment, the data collected by a set of sensors at the resource site may include data associated with the number of wells of a first reservoir or second reservoir at the resource site, data associated with the number of grid cells of the first or second reservoir, data associated with the average permeability of the first or second reservoir, data associated with the production duration history (e.g., number of years of production) of the first reservoir or second, etc.

Data acquisition tool 202a is illustrated as a measurement truck, which may comprise devices or sensors that take measurements of the subsurface through sound vibrations such as, but not limited to, seismic measurements. Drilling tool 202b may include a downhole sensor adapted to perform logging while drilling (LWD) data collection. The wireline tool 202c may include a downhole sensor deployed in a wellbore or borehole. Production tool 202d may be deployed from a production unit or Christmas tree into a completed wellbore. Examples of resource site data that may be measured include weight on bit, torque on bit, subterranean pressures (e.g., underground fluid pressure), temperatures, flow rates, compositions, rotary speed, particle count, voltages, currents, and/or other parameters of operations as further discussed below.

Sensors may be positioned about the resource site to collect data relating to various resource site operations, such as sensors deployed by the data acquisition tools 202. The sensors may include any type of sensor such as a metrology sensor (e.g., temperature, humidity), an automation enabling sensor, an operational sensor (e.g., pressure sensor, H₂S sensor, thermometer, depth, tension), evaluation sensors, or other sensors that can be used for acquiring data regarding a formation, wellbore, formation fluid, wellbore fluid, gas/oil/water comprised in the formation/wellbore fluid associated with the resource site. For example, the sensors may include accelerometers, flow rate sensors, pressure transducers, electromagnetic sensors, acoustic sensors, temperature sensors, chemical agent detection sensors, nuclear sensor, and/or any additional suitable sensors.

In one embodiment, the data captured by the one or sensors may be used to characterize, or otherwise generate one or more parameter values for a high-resolution result set used to, for example, label or configure a machine learning (ML) engine, a resource model as the case may require. In other embodiments, test data or synthetic data may also be used in developing the ML engine or resource model via one or more parameterization/labeling operations such as those discussed in association with the workflows presented herein.

Evaluation sensors may be featured in downhole tools such as tools 202b-202d and may include for instance electromagnetic, acoustic, nuclear, and optic sensors. Examples of tools including evaluation sensors that can be used in the framework of the current method include electromagnetic tools including imaging sensors such as FMI™ or QuantaGeo™ (mark of SLB, Houston, TX); induction sensors such as Rt Scanner™ (mark of SLB, Houston, TX), multifrequency dielectric dispersion sensor such as Dielectric Scanner™ (mark of SLB, Houston, TX); acoustic tools including sonic sensors, such as Sonic Scanner™ (mark of SLB, Houston, TX) or ultrasonic sensors, such as pulse-echo sensor as in UBI™ or PowerEcho™ (marks of SLB, Houston, TX) or flexural sensors PowerFlex™ (mark of SLB, Houston, TX); nuclear sensors such as Litho Scanner™ (mark of SLB, Houston, TX) or nuclear magnetic resonance sensors; fluid sampling tools including fluid analysis sensors such as InSitu Fluid Analyzer™ (mark of SLB, Houston, TX); distributed sensors including fiber optic. Such evaluation sensors may be used in particular for evaluating the formation in which the well is formed (i.e., determining petrophysical or geological properties of the formation), for verifying the integrity of the well (such as casing or cement properties) and/or analyzing the produced fluid (flow, type of fluid, etc.).

As shown, data acquisition tools 202a-202d may generate data plots or measurements 208a-208d, respectively. These data plots are depicted within the resource site 200 to demonstrate that data generated by some of the operations executed at the resource site 200.

Data plots 208a-208c are examples of static data plots that may be generated by data acquisition tools 202a-202c, respectively. However, it is herein contemplated that data plots 208a-208c may also be data plots that may be generated and updated in real time. These measurements may be analyzed to better define properties of the formation(s) and/or determine the accuracy of the measurements and/or check for and compensate for measurement errors. The plots of each of the respective measurements may be aligned and/or scaled for comparison and verification purposes. In some embodiments, base data associated with the plots may be incorporated into site planning, modeling a test at the resource site 200. The respective measurements that can be taken may be any of the above.

Other data may also be collected, such as historical data of the resource site 200 and/or sites similar to the resource site 200, user inputs, information (e.g., economic information) associated with the resource site 200 and/or sites similar to the resource site 200, and/or other measurement data and other parameters of interest. Similar measurements may also be used to measure changes in formation aspects over time.

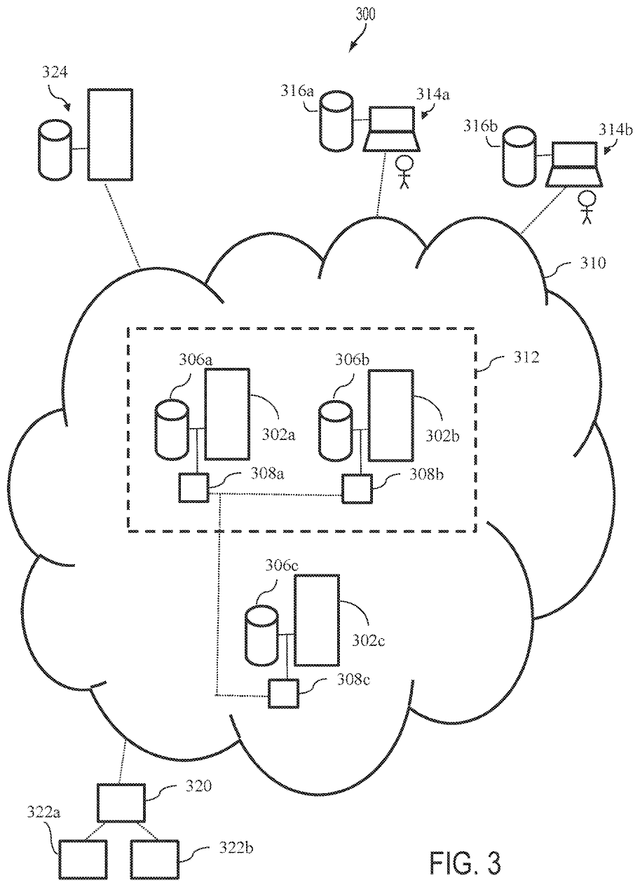

Computer facilities such as those discussed in association with FIG. 3 may be positioned at various locations about the resource site 200 (e.g., a surface unit) and/or at remote locations. A surface unit (e.g., one or more terminals 320) may be used to communicate with the onsite tools and/or offsite operations, as well as with other surface or downhole sensors. The surface unit may be capable of sending commands to the oil field equipment/systems, and receiving data therefrom. The surface unit may also collect data generated during production operations and can produce output data, which may be stored or transmitted for further processing.

The data collected by sensors may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis or for modeling purposes to optimize production processes at the resource site 200. In one embodiment, the data is stored in separate databases, or combined into a single database.

### Network System

FIG. 3 shows a high-level network system 300 illustrating a communicative coupling of devices or systems associated with the resource site 200 as described in FIG. 2. The system shown in the figure may include a set of processors 302a, 302b, and 302c for executing one or more processes discussed herein. The set of processors 302 may be electrically coupled to one or more servers (e.g., computing systems) including memory 306a, 306b, and 306c that may store for example, program data, databases, and other forms of data. Each server of the one or more servers may also include one or more communication devices 308a, 308b, and 308c. The set of servers may provide a cloud-computing platform 310. In one embodiment, the set of servers includes different computing devices that are situated in different locations and may be scalable based on the needs and workflows associated with the resource site 200. The communication devices of each server may enable the servers to communicate with each other through a local or global network such as an Internet network. In some embodiments, the servers may be arranged as a town 312, which may provide a private or local cloud service for users. A town may be advantageous in remote locations with poor connectivity. Additionally, a town may be beneficial in scenarios with large networks where security may be of concern. A town in such large network embodiments can facilitate implementation of a private network within such large networks. The town may interface with other towns or a larger cloud network, which may also communicate over public communication links. Note that cloud-computing platform 310 may include a private network and/or portions of public networks. In some cases, a cloud-computing platform 310 may include remote storage and/or other application processing capabilities.

The system of FIG. 3 may also include one or more user terminals 314a and 314b each including at least a processor to execute programs, a memory (e.g., 316a and 316b) for storing data, a communication device and one or more user interfaces and devices that enable the user to receive, view, and transmit information. In one embodiment, the user terminals 314a and 314b is a computing system having interfaces and devices including keyboards, touchscreens, display screens, speakers, microphones, a mouse, styluses, etc. The user terminals 314 may be communicatively coupled to the one or more servers of the cloud-computing platform 310. The user terminals 314 may be client terminals or expert terminals, enabling collaboration between clients and experts through the system of FIG. 3.

The system of FIG. 3 may also include at least one or more resource sites 200 having, for example, a set of terminals 320, each including at least a processor, a memory, and a communication device for communicating with other devices communicatively coupled to the cloud-computing platform 310. The resource site 200 may also have a set of sensors (e.g., one or more sensors described in association with FIG. 2) or sensor interfaces 322a and 322b communicatively coupled to the set of terminals 320 and/or directly coupled to the cloud-computing platform 310. In some embodiments, data collected by the set of sensors/sensor interfaces 322a and 322b may be processed to generate a one or more resource models (e.g., reservoir models) or one or more resolved data sets used to generate the resource model which may be displayed on a user interface associated with the set of terminals 320, and/or displayed on user interfaces associated with the set of servers of the cloud computing platform 310, and/or displayed on user interfaces of the user terminals 314. Furthermore, various equipment/devices discussed in association with the resource site 200 may also be communicatively coupled to the set of terminals 320 and or communicatively coupled directly to the cloud-computing platform 310. The equipment and sensors may also include one or more communication device(s) that may communicate with the set of terminals 320 to receive orders/instructions locally and/or remotely from the resource site 200 and also send statuses/updates to other terminals such as the user terminals 314.

The system of FIG. 3 may also include one or more client servers 324 including a processor, memory, and communication device. For communication purposes, the client servers 324 may be communicatively coupled to the cloud-computing platform 310, and/or to the user terminals 314a and 314b, and/or to the set of terminals 320 at the resource site 200 and/or to sensors at the oil field, and/or to other equipment at the resource site 200.

A processor, as discussed with reference to the system of FIG. 3, may include a microprocessor, a graphical processing unit (GPU), a microcontroller, a processor module or subsystem, a programmable integrated circuit, a programmable gate array, or another control or computing device.

The memory/storage media discussed above in association with FIG. 3 can be implemented as one or more computer-readable or machine-readable storage media that are non-transitory. In some embodiments, storage media may be distributed within and/or across multiple internal and/or external enclosures of a computing system and/or additional computing systems. Storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs), BluRays or any other type of optical media; or other types of storage devices. “Non-transitory” computer readable medium refers to the medium itself (i.e., tangible, not a signal) and not data storage persistency (e.g., RAM vs. ROM).

Note that instructions can be provided on one computer-readable or machine-readable storage medium, or alternatively, can be provided on multiple computer-readable or machine-readable storage media distributed in a large system having possibly plural nodes and/or non-transitory storage means. Such computer-readable or machine-readable storage medium or media is (are) considered to be part of an article (or article of manufacture). The storage medium or media can be located either in a computer system running the machine-readable instructions, or located at a remote site from which machine-readable instructions can be downloaded over a network for execution.

It is appreciated that the described system of FIG. 3 is an example that may have more or fewer components than shown, may combine additional components, and/or may have a different configuration or arrangement of the components. The various components shown may be implemented in hardware, software, or a combination of both, hardware, and software, including one or more data processing and/or application specific integrated circuits.

Further, the steps in the flowcharts described below may be implemented by running one or more functional modules in an information processing apparatus such as general-purpose processors or application specific chips, such as ASICs, FPGAs, PLDs, GPUs or other appropriate devices associated with the system of FIG. 3. For example, the flowchart of FIG. 1 as well as the flowcharts below may be executed using a data engine/a data processing module (e.g., computing module) stored in memory 306a, 306b, or 306c such that the data engine/data processing module includes instructions that are executed by the one or more processors such as processors 302a, 302b, or 302c as the case may be. The various modules of FIG. 3, combinations of these modules, and/or their combination with general hardware are included within the scope of protection of the disclosure. While one or more computing processors (e.g., processors 302a, 302b, or 302c) may be described as executing steps associated with one or more of the flowcharts described in this disclosure, the one or more computing device processors may be associated with the cloud-based computing platform 310 and may be located at one location or distributed across multiple locations. In one embodiment, the one or more computing device processors may also be associated with other systems of FIG. 3 other than the cloud-computing platform 310.

In some embodiments, a computing system is provided that includes at least one processor, at least one memory, and one or more programs stored in the at least one memory, such that the programs comprise instructions, which when executed by the at least one processor, are configured to perform any method disclosed herein.

In some embodiments, a computer readable storage medium is provided, which has stored therein one or more programs, the one or more programs including instructions, which when executed by a processor, cause the processor to perform any method disclosed herein. In some embodiments, a computing system is provided that includes at least one processor, at least one memory, and one or more programs stored in the at least one memory for performing any method disclosed herein. In some embodiments, an information processing apparatus for use in a computing system is provided for performing any method disclosed herein.

### Embodiments

The disclosed technology provides methods and systems that address complexities and/or challenges associated with horizon interpretation operations to generate multidimensional reports associated with a subsurface. In particular, the disclosed methods and systems address issues associated with analysis operations for processing complex seismic data. In particular, the analysis operations may require processing sets of seismic data (e.g. large, and/or intricate, and/or complex sets of seismic data) including image data such that a person or a group of persons will not be able to feasibly perform such analysis operations on the sets of seismic data within, for example, a given timeframe. It is appreciated that the disclosed techniques not only address the complexities or challenges involved in horizon interpretation operations but also overcome said complexities and/or challenges by reducing the time associated with said operations, and/or eliminating laborious processes associated with said operations thereby significantly truncating the workflow time required for full interpretation or analysis of horizon or subsurface data (e.g., subsurface seismic data).

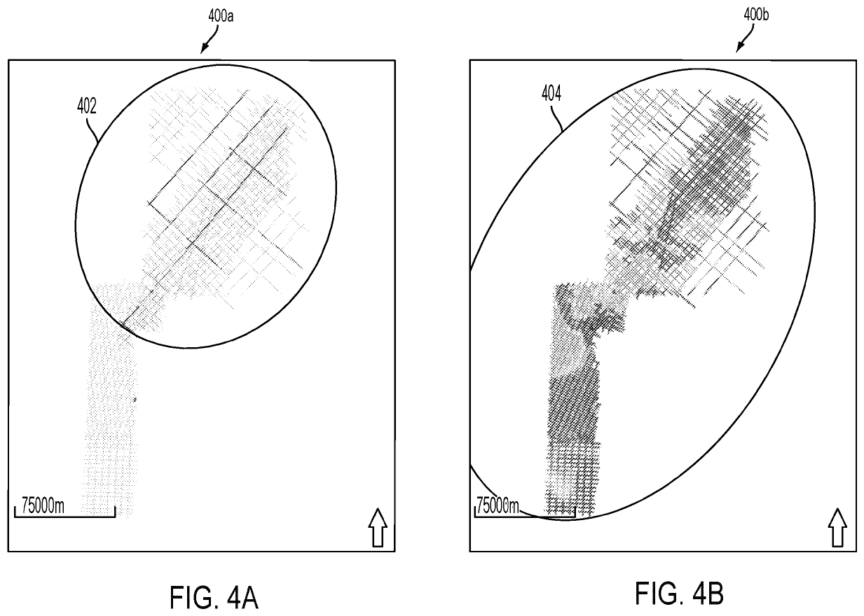

As exemplified in the visualization 400a of FIG. 4A for example, an ML engine may be parameterized or otherwise constrained using a first dataset comprising one or more boundary condition data indicating similar and/or dissimilar and/or parallel and/or nonparallel linear data points 402 as shown in the figure. According to one embodiment, the boundary condition data may qualitatively and/or quantitatively provide an initial data structure or data construct used by the ML engine to analyze and/or process the captured seismic data. In some embodiments, analyzing and/or processing the captured seismic data may comprise resolving the captured seismic data using the first dataset into a clearly defined, improved, or enhanced multidimensional report such as the one shown in the visualization 400b of FIG. 4B.

As can be seen in FIG. 4B, the ML engine, as part of processing and/or analyzing the seismic data may: color code; linearly or nonlinearly section a plurality of regions of the seismic data; and/or geometrically construct one or more subsurface property information comprised in, or associated with, the captured seismic data to generate the multidimensional report.

The multidimensional report of FIG. 4B, for example, may indicate resolution information indicating one or more of rock property data in the subsurface, fluid flow condition data in the subsurface, air gap data within the subsurface, subsurface discontinuity data, subsurface layering data, hydrocarbon data associated with the subsurface, mineral deposit data associated with the subsurface, etc.

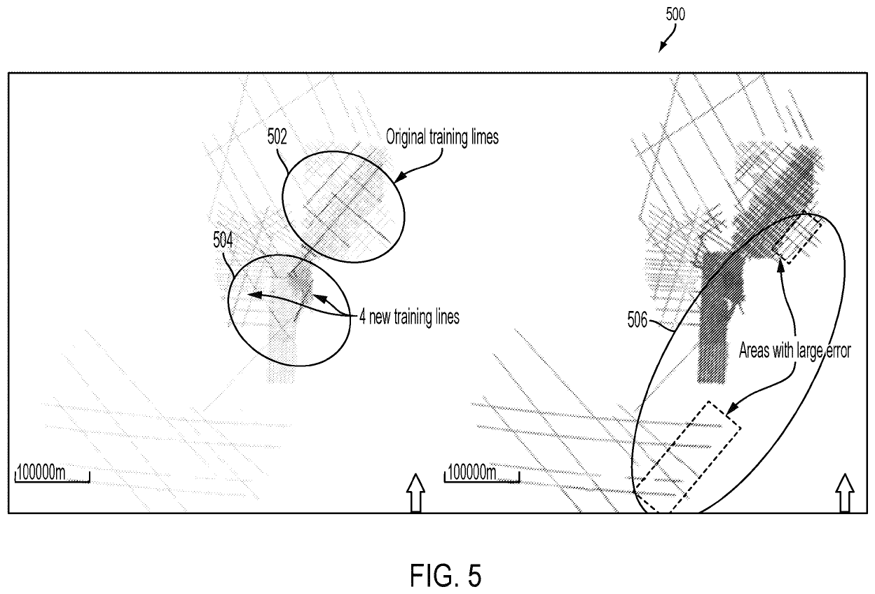

According to some implementations, a quality control operation may be executed on the multidimensional report to determine whether the multidimensional report, for example, probabilistically satisfies value (e.g., expected value) conditions of at least one of the first dataset, historical data associated with the resource site from which the seismic data was captured, and/or domain information (e.g., from a subject-matter expert) associated with the resource site. For example, FIG. 5 shows a visualization 500 indicating a quality control operation executed on a multidimensional report generated using the ML engine. As can be seen in the figure, one or more data points (e.g., data points 502) associated with the first dataset may be identified and correlated with geometrically constructed subsurface information (e.g., subsurface information 504). Looking at the zoomed-in correlation 506 of the data comprised in data points 502 and 504, it can be determined, based on the example shown, that there are areas with errors within the multidimensional report. Such areas may be automatically removed or otherwise cleared in a data cleaning process before and/or during a second analysis of the multidimensional report, in for example, a second iteration, a third iteration, a fourth iteration, or an “n^{th}” iteration of the analysis. These aspects are further discussed in conjunction with the flowchart of FIG. 6.

It is appreciated that the disclosed processes facilitate horizon interpretation using an ML engine in real-time or near-real-time according to some embodiments. In some cases, the ML engine may process the multidimensional seismic data within a few microseconds or a few seconds (e.g., 10 seconds, 20 seconds, 30 seconds, etc.) or within a few minutes (e.g., 1 minute, 2 minutes, 3 minutes, etc.) or within a few hours (1 hour, 2 hours, 3 hours, etc.) or within a few days (1 day, 2 days, 3 days, etc.) or within a few weeks (e.g., 1 week, or two weeks) depending on one or more of: the size; and/or complexity of the seismic data; and/or the location from which the seismic data was captured; and/or the period within which the seismic data was captured; and/or geo-properties of the subsurface from which the seismic data was captured.

According to some embodiments, the disclosed techniques enable reception of one or more user inputs that optimize the operation of the ML engine to more efficiently and/or accurately generate outputs (e.g., textual and/or image data comprised in a multidimensional report) that reflect characterizations of the subsurface of a resource site based on the captured seismic data. In some embodiments, the disclosed techniques may be applied to subsurface horizon interpretation workflows, including but not limited to: Oil and Gas reservoir characterizations; carbon capture, monitoring, utilization, and storage (CCUS) operations; wind farm turbine placement operations including turbines and cable runs; compressed air storage site location operations and characterizations; etc. According to one embodiment, the disclosed subsurface horizon interpretation workflows can be part of or comprised in a software program or an application (e.g., a geological application such as the Petrel software platform).

### Detailed Workflow

FIG. 6 shows an exemplary detailed workflow 600 for analyzing seismic data. It is appreciated that a data engine or a data managing module stored in a memory device may cause a computer processor to execute the various processing stages of the workflow 600. For example, the disclosed techniques may be implemented as a data engine within a geological software tool such that the data engine enables optimally analyzes seismic data based on the processes outlined herein.

At block 602, the data engine receives first seismic data captured at a resource site by one or more sensors. According to one embodiment, the first seismic data comprises subsurface information and noise data associated with the resource site.

At block 604, the data engine constrains a machine learning (ML) engine to analyze the seismic data using a first dataset. Constraining the ML engine can comprise customizing or labeling the ML engine with one or more boundary condition data (e.g., constraint data or label data) associated with one or more subsurface geo-properties comprised in the first seismic data. For example, the data engine may be programmed to automatically constrain the ML engine in some implementations. In other implementations, one or more inputs from, for example, a user (e.g., a subject-matter expert), may be received by the data engine such that said inputs are used to constrain the ML engine. In an exemplary embodiment, constraining the ML engine may be facilitated by receiving an input from the user such that the input corresponds to a portion or percentage (e.g., 1%, 2%, 3%, etc.) of the initial constraints or labels applied to the ML engine prior to analyzing the first seismic data. According to one embodiment, the geo-properties may comprise subsurface morphological data that provide insight into geological structures in the subsurface of the resource site. In addition, the one or more boundary condition data may indicate one or more limit data, threshold data, or other statistical parameter data used to impose bounds on the analysis executed by the ML engine.

Turning to block 606, the data engine may analyze the first seismic data in a first iteration based on the constrained ML engine to generate a multidimensional report.

In addition, the data engine may determine, at block 608, whether to execute a second analysis operation on the generated multidimensional report in a second iteration based on at least one of: an update of the first dataset used for labeling the ML engine; or a second dataset distinct from the first dataset and which indicates optimized boundary condition data associated with the resource site.

In response to determining that a second analysis operation is not required, the data engine may execute, at block 610, using the multidimensional report one or more of: determining an optimal site associated with the subsurface of the resource site to install a wind turbine; determining an optimal drill rate for controlling a drill bit boring one or more holes into the subsurface associated with the resource site; determining an optimal well location to guide a drill bit boring one or more holes into the subsurface associated with the resource site such that the drill rate is based on, for example, layering data comprised in the multidimensional report; determining an optimal well location to guide a drill bit boring one or more holes into the subsurface associated with the resource site; determining an optimal subsurface location to store a captured gas (e.g. CO₂, methane, etc.); or executing one or more hydrocarbon exploration operations in the subsurface of the resource site.

In other embodiments, a system and a computer program can include or execute the method described above. These and other implementations may each optionally include one or more of the following features.

The boundary condition data, according to some embodiments, indicates one or more of: similar or dissimilar data points associated with the ML engine; parallel or nonparallel linear data points associated with the ML engine; or qualitative or quantitative data providing an initial data structure or data construct used by the ML engine to analyze the first seismic data.

In some implementations, analyzing the first seismic data in the first iteration based on the constrained ML engine comprises one or more of: resolving the captured seismic data using the first dataset into a defined data structure comprised in the multidimensional report; color coding one or more sections of the defined data structure comprised in the multidimensional report; linearly or nonlinearly sectioning a plurality of regions of the seismic data for inclusion in the defined data structure; or geometrically constructing one or more subsurface property information comprised in, or associated with the captured seismic data to generate the multidimensional report.

Furthermore, the multidimensional report can indicate one or more of: resolution information indicating one or more of rock property data comprised in the subsurface information; fluid flow condition data comprised in the subsurface information; air gap data comprised in the subsurface information; subsurface continuity or discontinuity data comprised in the subsurface information; subsurface layering data comprised in the subsurface information; hydrocarbon data associated with the subsurface information; or mineral deposit data associated with the subsurface information.

In some cases, flowchart 600 comprises executing, using the data engine, a quality control operation including at least cleaning the multidimensional report to eliminate at least one of: an error comprised in the multidimensional report; or the noise comprised in the first seismic data.

Moreover, it is appreciated that the quality control operation is executed to determine whether the multidimensional report probabilistically satisfies value conditions (e.g., boundary conditions) associated with at least one of: the first dataset; historical data associated with the resource site from which the seismic data was captured; or domain information (e.g., from a subject-matter expert) associated with the resource site.

In some instances, the multidimensional report comprises one of 2-dimensional data or 3-dimensional data.

In particular, the multidimensional report can comprise one of 2-dimensional image data or 3-dimensional image data associated with a subsurface of the resource site. In one embodiment, the multidimensional report comprises image data that may be further assessed by the data engine based on one or more of: location information associated with the first seismic data or the second seismic data; subsurface property information associated with the first seismic data or the second seismic data; or tolerance information associated with the boundary condition data. In some implementations, a filtering operation may be applied to the multidimensional report, as part of analyzing the first seismic data or the second seismic data by the data managing module to align actual geo-property data comprised in the first seismic data or the second seismic data with the boundary condition data discussed in conjunction with flowchart 600.

In response to determining that a second iteration is required, the data engine may be used to further analyze the multidimensional report in a second iteration, or a third iteration, or a fourth iteration, or an “n^{th}” iteration based on one of: the update of the first dataset used for labeling the boundary condition data; or the second dataset distinct from the first dataset and which indicates optimized boundary condition data associated with the resource site.

In some embodiments, the data engine may: simultaneously constrain one or more ML engines using the first dataset or the second dataset, or a third data set similarly as done at block 604 above; simultaneously analyze a plurality of seismic data from the resource site and/or from a resource site similar to or different from the resource site using the simultaneously constrained one or more ML engines to generate an aggregate multidimensional report comprising a plurality of multidimensional reports compiled from analyzing the plurality of seismic data; and simultaneously determine whether to execute additional analysis operations on the aggregate multidimensional report.

In response to determining that no additional analysis operations are required for the aggregate report, the data engine may execute one or more of the operations outlined in conjunction with block 610 above.

It is appreciated that the aggregate multidimensional report may comprise a plurality of 2-dimensional and/or 3-dimensional image data that may or may not be superimposed on top of each other based on the simultaneous analysis of the plurality of seismic data using the simultaneously constrained one or more ML engines.

It is further appreciated that an operation referenced herein can be a computing operation requiring the use of one or more data engines powering or driving a computer processor to execute the disclosed methods and systems.

While any discussion of or citation to related art in this disclosure may or may not include some prior art references, it is to be understood that such discussions of or citations to is neither a concession nor acquiescence to the position that any given reference is prior art or analogous prior art.

The foregoing description, for purpose of explanation, has been described with reference to specific embodiments. However, the illustrative discussions above are not intended to be exhaustive or to limit the foregoing subject-matter to the precise forms disclosed. Many modifications and variations are possible in view of the above teachings. The embodiments were chosen and described in order to explain the principles of this disclosure and its practical applications, to thereby enable others skilled in the art to use the disclosed solution and various embodiments with various modifications as are suited to the particular use contemplated. It is appreciated that the term optimize/optimal and its variants (e.g., efficient or optimally) may simply indicate improving, rather than the ultimate form of ‘perfection’ or the like.

It will also be understood that, although the terms first, second, etc., may be used herein to describe various elements, these elements should not be limited by these terms. These terms are used to distinguish one element from another. For example, a first object or step could be termed a second object or step, and, similarly, a second object or step could be termed a first object or step, without departing from the scope of this disclosure. The first object or step, and the second object or step, are both objects or steps, respectively, but they are not to be considered the same object or step.

The terminology used in the description herein is for the purpose of describing particular embodiments and is not intended to be limiting. As used in the description of this disclosure and the appended claims, the singular forms “a,” “an” and “the” are intended to include the plural forms as well, unless the context clearly indicates otherwise. It will also be understood that the term “and/or” as used herein refers to and encompasses any possible combination of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context.

Those with skill in the art will appreciate that while some terms in this disclosure may refer to absolutes, e.g., all source receiver traces, each of a plurality of objects, etc., the methods and techniques disclosed herein may also be performed on fewer than all of a given thing, e.g., performed on one or more components and/or performed on one or more source receiver traces. Accordingly, in instances in the disclosure where an absolute is used, the disclosure may also be interpreted to be referring to a subset.

What is claimed is:

1. A method for analyzing seismic data, the method comprising:
receiving first seismic data captured at a resource site by one or more sensors, the first seismic data comprising subsurface information and noise data;
constraining a machine learning (ML) engine for analyzing the seismic data using a first dataset, wherein constraining the ML engine comprises customizing or labeling the ML engine with one or more boundary condition data associated with one or more subsurface geo-properties comprised in the first seismic data;
analyzing the first seismic data in a first iteration based on the constrained ML engine to generate a multidimensional report;
determining whether to execute a second analysis operation on the generated multidimensional report in a second iteration based on at least one of:
an update of the first dataset used for labeling the ML engine; or
a second dataset distinct from the first dataset and which indicates optimized boundary condition data associated with the resource site;
in response to determining that a second analysis operation is not required, executing, using the multidimensional report one or more of:
determining an optimal site associated with the subsurface of the resource site to install a wind turbine;
determining an optimal drill rate for controlling a drill bit boring one or more holes into the subsurface associated with the resource site;
determining an optimal well location to guide a drill bit boring one or more holes into the subsurface associated with the resource site;
determining an optimal subsurface location to store a captured gas; or
executing one or more hydrocarbon exploration operations in the subsurface of the resource site.

2. The method of claim 1, wherein the boundary condition data indicates one or more of:
similar or dissimilar data points associated with the ML engine;
parallel or nonparallel linear data points associated with the ML engine; or
qualitative or quantitative data providing an initial data structure or data construct used by the ML engine to analyze the first seismic data.

3. The method of claim 1, wherein analyzing the first seismic data in the first iteration based on the constrained ML engine comprises one or more of:
resolving the captured seismic data using the first dataset into a defined data structure comprised in the multidimensional report;
color coding one or more sections of the defined data structure comprised in the multidimensional report;
linearly or nonlinearly sectioning a plurality of regions of the seismic data for inclusion in the defined data structure; or
geometrically constructing one or more subsurface property information comprised in, or associated with the captured seismic data to generate the multidimensional report.

4. The method of claim 1, wherein the multidimensional report indicates one or more of:
resolution information indicating one or more of rock property data comprised in the subsurface information;
fluid flow condition data comprised in the subsurface information;
air gap data comprised in the subsurface information;
subsurface continuity or discontinuity data comprised in the subsurface information;
subsurface layering data comprised in the subsurface information;
hydrocarbon data associated with the subsurface information; or
mineral deposit data associated with the subsurface information.

5. The method of claim 1, further comprising executing a quality control operation comprising at least cleaning the multidimensional report to eliminate at least one of:
an error comprised in the multidimensional report; or
the noise comprised in the first seismic data.

6. The method of claim 5, wherein the quality control operation is executed to determine whether the multidimensional report probabilistically satisfies value conditions associated with at least one of:
the first dataset;
historical data associated with the resource site from which the seismic data was captured; or
domain information associated with the resource site.

7. The method of claim 1, wherein the multidimensional report comprises image data.

8. The method of claim 1, wherein the multidimensional report comprises one of 2-dimensional data or 3-dimensional data.

9. The method of claim 1, wherein in response to determining that a second iteration is required, analyzing the multidimensional report in a second iteration based on one of:
the update of the first dataset used for labeling the boundary condition data; or
the second dataset distinct from the first dataset and which indicates optimized boundary condition data associated with the resource site.

10. A system comprising:
a computer processor, and
memory storing a data processing engine that comprises instructions that are executable by the computer processor to:
receive first seismic data captured at a resource site by one or more sensors, the first seismic data comprising subsurface information and noise data;
constrain a machine learning (ML) engine for analyzing the seismic data using a first dataset, wherein to constrain the ML engine comprises customizing or labeling the ML engine with one or more boundary condition data associated with one or more subsurface geo-properties comprised in the first seismic data;
analyze the first seismic data in a first iteration based on the constrained ML engine to generate a multidimensional report;
determine whether to execute a second analysis operation on the generated multidimensional report in a second iteration based on at least one of:
an update of the first dataset used for labeling the ML engine; or
a second dataset distinct from the first dataset and which indicates optimized boundary condition data associated with the resource site;
in response to determining that a second analysis operation is not required, execute, using the multidimensional report one or more of:
determining an optimal site associated with the subsurface of the resource site to install a wind turbine;
determining an optimal drill rate for controlling a drill bit boring one or more holes into the subsurface associated with the resource site;
determining an optimal subsurface location to store a captured gas; or
executing one or more hydrocarbon exploration operations within the subsurface of the resource site.

11. The system of claim 10, wherein the boundary condition data indicates one or more of:
similar or dissimilar data points associated with the ML engine;
parallel or nonparallel linear data points associated with the ML engine; or
qualitative or quantitative data providing an initial data structure or data construct used by the ML engine to analyze the first seismic data.

12. The system of claim 10, wherein analyzing the first seismic data in the first iteration based on the constrained ML engine comprises one or more of:
resolving the captured seismic data using the first dataset into a defined data structure comprised in the multidimensional report;
color coding one or more sections of the defined data structure comprised in the multidimensional report;
linearly or nonlinearly sectioning a plurality of regions of the seismic data for inclusion in the defined data structure; or
geometrically constructing one or more subsurface property information comprised in, or associated with the captured seismic data to generate the multidimensional report.

13. The system of claim 10, wherein the multidimensional report indicates one or more of:
resolution information indicating one or more of rock property data comprised in the subsurface information;
fluid flow condition data comprised in the subsurface information;
air gap data comprised in the subsurface information;
subsurface discontinuity data comprised in the subsurface information;
subsurface layering data comprised in the subsurface information;
hydrocarbon data associated with the subsurface information; or
mineral deposit data associated with the subsurface information.

14. The system of claim 10, wherein the multidimensional report comprises image data.

15. The system of claim 10, wherein the multidimensional report comprises one of 2-dimensional data or 3-dimensional data.

16. The system of claim 10, wherein in response to determining that a second iteration is required, the instructions may be executable by the computer processor to analyze the multidimensional report in a second iteration based on one of:
the update of the first dataset used for labeling the boundary condition data; or
the second dataset distinct from the first dataset and which indicates optimized boundary condition data associated with the resource site.

17. A computer program for analyzing seismic data, the computer program comprising instructions, that when executed by a computer processor of a computing device, causes the computing device to:
receive first seismic data captured at a resource site by one or more sensors, the first seismic data comprising subsurface information and noise data;
constrain a machine learning (ML) engine for analyzing the seismic data using a first dataset, wherein to constrain the ML engine comprises customizing or labeling the ML engine with one or more boundary condition data associated with one or more subsurface geo-properties comprised in the first seismic data;
analyze the first seismic data in a first iteration based on the constrained ML engine to generate a multidimensional report;
determine whether to execute a second analysis operation on the generated multidimensional report in a second iteration based on at least one of:
an update of the first dataset used for labeling the ML engine; or
a second dataset distinct from the first dataset and which indicates optimized boundary condition data associated with the resource site;
in response to determining that a second analysis operation is not required, execute, using the multidimensional report one or more of:
determining an optimal site associated with the subsurface of the resource site to install a wind turbine;
determining an optimal drill rate for controlling a drill bit boring one or more holes into the subsurface associated with the resource site;
determining an optimal subsurface location to store a captured gas; or
executing one or more hydrocarbon exploration operations within the subsurface of the resource site.

18. The computer program of claim 17, wherein the boundary condition data indicates one or more of:
similar or dissimilar data points associated with the ML engine;
parallel or nonparallel linear data points associated with the ML engine; or
qualitative or quantitative data providing an initial data structure or data construct used by the ML engine to analyze the first seismic data.

19. The computer program of claim 17, wherein analyzing the first seismic data in the first iteration based on the constrained ML engine comprises one or more of:
resolving the captured seismic data using the first dataset into a defined data structure comprised in the multidimensional report;
color coding one or more sections of the defined data structure comprised in the multidimensional report;
linearly or nonlinearly sectioning a plurality of regions of the seismic data for inclusion in the defined data structure; or
geometrically constructing one or more subsurface property information comprised in, or associated with the captured seismic data to generate the multidimensional report.

20. The computer program of claim 17, wherein the multidimensional report comprises one of 2-dimensional image data or 3-dimensional image data associated with a subsurface of the resource site.
